(19) United States
(12) Patent Application Publication
(10) Pub. No.: US 2014/0210689 A1
(43) Pub. Date: Jul. 31, 2014

(54) GLASSES AND MEDIA PLAYING FUNCTION

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/010,555

(22) Filed: Aug. 27, 2013

(30) Foreign Application Priority Data
Jan. 31, 2013 (TW) 102103707

(51) Int. Cl. G09G 5/12

(52) U.S. Cl. CPC G09G 5/12
USPC 345/1.3

(57) ABSTRACT

A pair of eyeglasses includes an eyeglass frame, a left lens, a right lens, a processor, a memory, an orientation sensor, and a location tracker. The eyeglasses contain left and right display screens. The memory stores image files, each image file is marked so as to be associated with a preset location information. The location tracker identifies a current location of the orientation sensor and transmits information as to a current location information of a user to the orientation sensor. The orientation sensor transmits the current location information to the processor, the processor presents for a set period a sequence of image files displayed on the display screens within the left and the right lenses.

### BACKGROUND

1. Technical Field

The present disclosure relates to media playing devices, and particularly to a pair of glasses having a media player function.

2. Description of Related Art

A pair of glasses having a media playing function usually include an eyeglass frame, a left lens and a right lens received in the eyeglass frame, and a memory element set on the eyeglass frame and configured for storing image files. The left and right lenses are a liquid crystal display (LCD) and are electrically connected to the memory element. A user wears the eyeglass frame on his head, where a left and right eyes of the user are relative to the left and right lenses, and when the user turns on the glasses playing device, the image files are played according to a set playback sequence through the left and right lenses. However, a user only views passive images, there is no interactivity.

Therefore, it is desirable to provide a glasses playing device, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a perspective view of a glasses playing device, according to an embodiment.

FIG. 2 is a functional structure chart of the glasses playing device of FIG. 1.

FIG. 3 is a diagram of the glasses playing device of FIG. 1 in a state of use.

FIG. 4 is a diagram showing the operating principles of the glasses playing device of FIG. 3.

### DETAILED DESCRIPTION

Embodiments will be described with reference to the drawings.

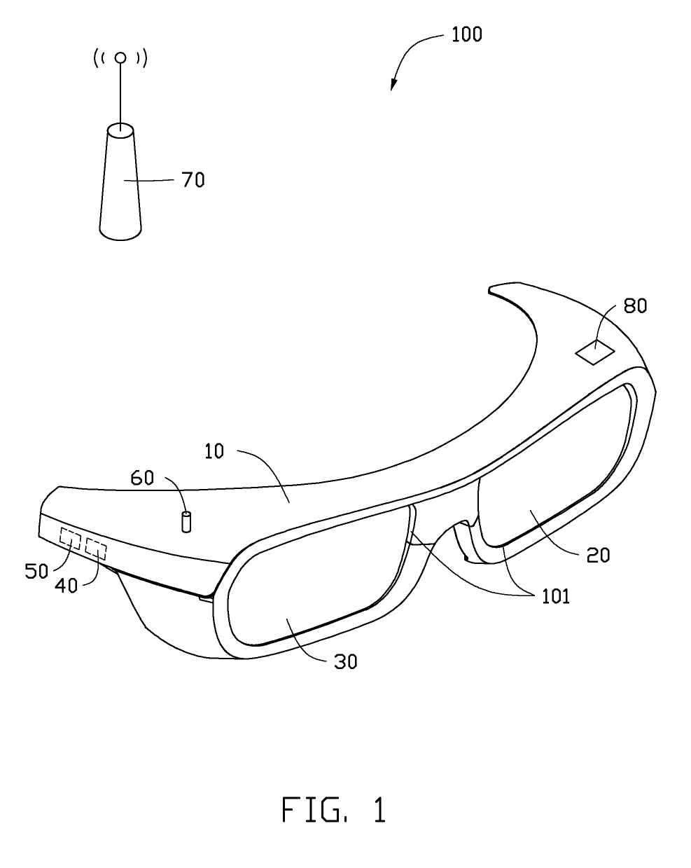

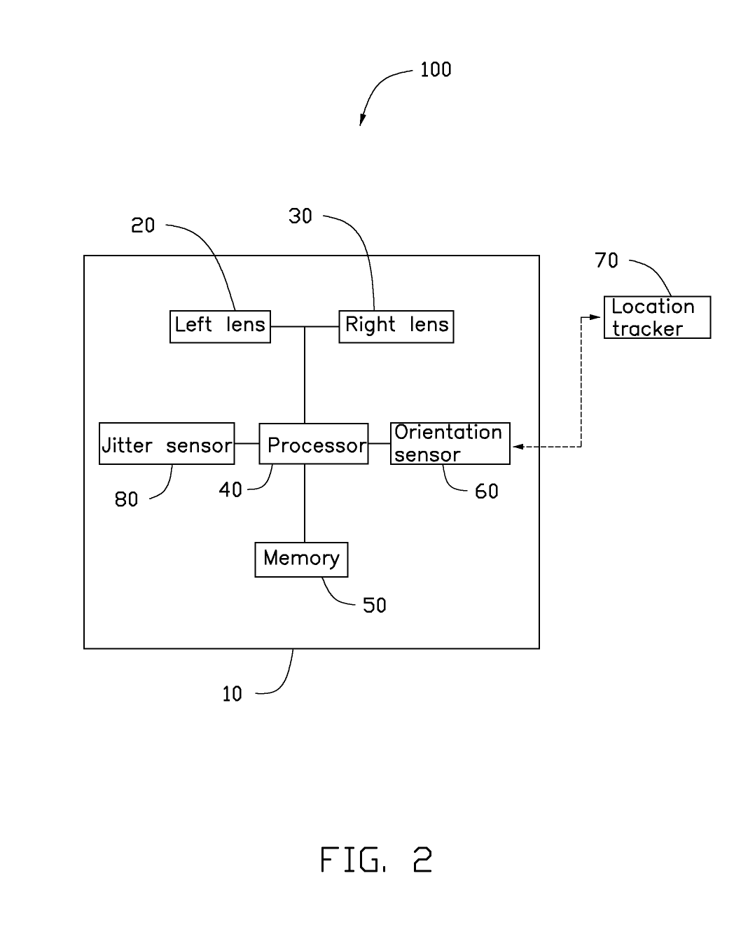

FIGS. 1 and 2 show a device (glasses playing device 100) capable of playing back or displaying electronic media files or other data according an exemplary embodiment. The glasses playing device 100 includes an eyeglass frame 10, a left lens 20, a right lens 30, a processor 40, a memory 50, an orientation sensor 60, and a location tracker 70.

The eyeglass frame 10 defines two receiving holes 101. The left lens 20 and the right lens 30 are received in the receiving holes 101. In the present embodiment, the left lens 20 and the right lens 30 are display devices, such as liquid crystal display (LCD).

The processor 40 is set within the eyeglass frame 10 and is electrically connected with the left lens 20 and the right lens 30.

The memory 50 is set within the eyeglass frame 10 and is electrically connected with the processor 40. The memory 50 stores image files and other data. In this embodiment, each image file is a picture file and includes at least one picture. In another embodiment, each image file is a video file including at least one video segment.

The orientation sensor 60 is set outside the eyeglass frame 10. In another embodiment, the orientation sensor 60 can be set within the eyeglass frame 10. The orientation sensor 60 is electrically connected with the processor 40. The orientation sensor 60 transmits a location detection signal to detect a preset locations information in a classroom 200.

The location tracker 70 is set individually from the eyeglass frame 10. The location tracker 70 receives the location detection signal through a wireless network. For example, the location detection signal may be received by the location tracker 70 through a WIFI network, the location detection signals confirm a current location of the orientation sensor 60, and such information is transmitted by the location tracker 70 via the wireless network to the orientation sensor 60. In this embodiment, the orientation sensor 60 includes a power signal transmitter, the location tracker 70 includes a power signal detector. The location tracker 70 according to a signal intensity transmitted by the orientation sensor 60 is able to determine the current location of the orientation sensor 60. In another embodiment, other existing techniques also can be used by the location tracker 70 to determine the current location of the orientation sensor 60.

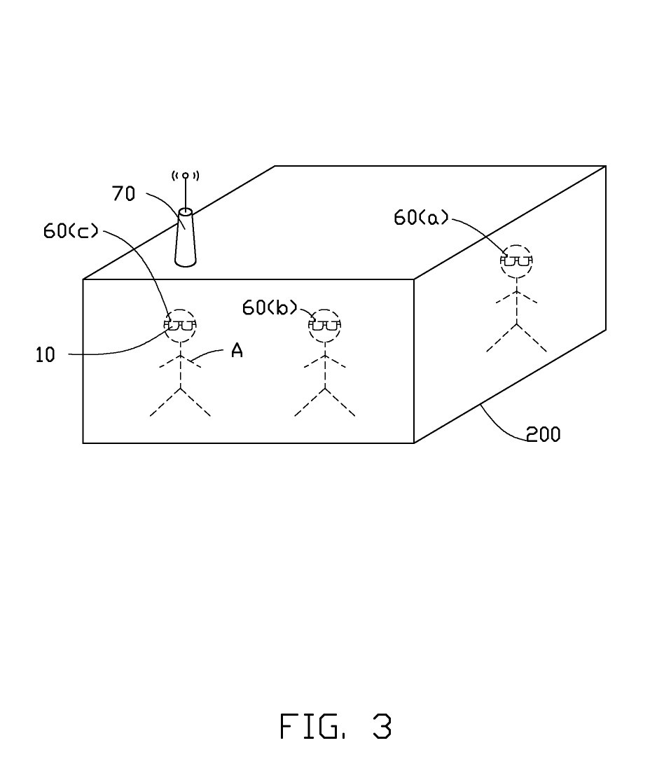

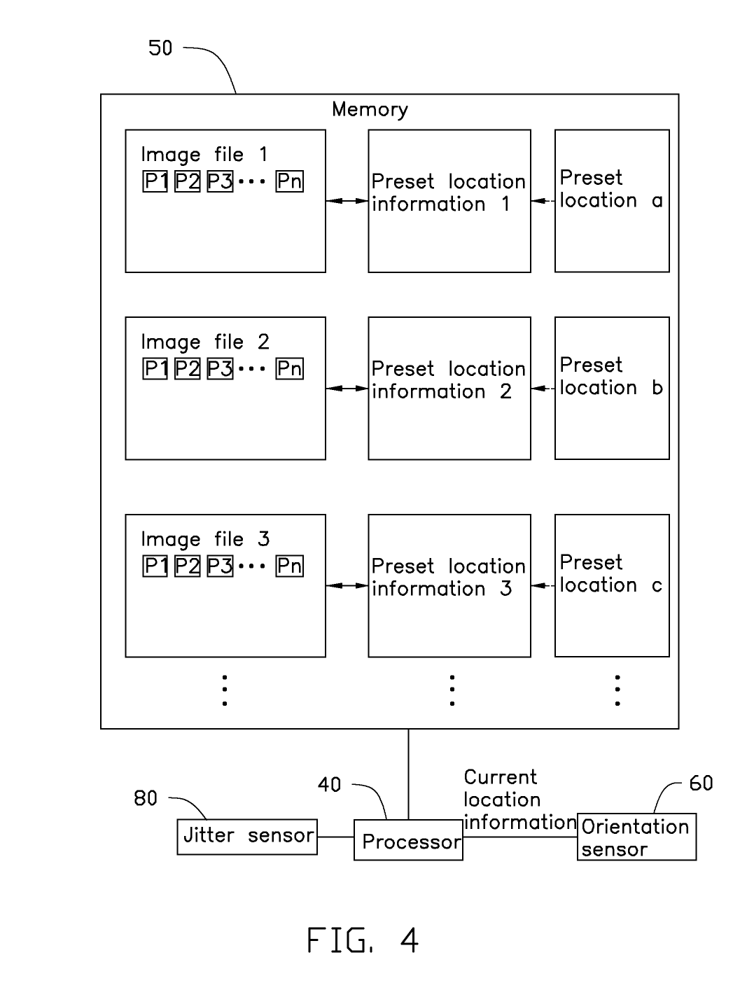

FIGS. 3 and 4 show an operating principle of the glasses playing device 100. For example, the glasses playing device 100 can be applied in the field of teaching, where the location tracker 70 is arranged on top of classroom 200. A user A wears the eyeglass frame 10, and a left eye of the user A sees the left lens 20 and a right eye of the user A sees the right lens 30. User A wears the eyeglass frame 10 as he moves within the classroom, relocating the orientation sensor 60 to multiple preset locations in the classroom 200, such as preset locations “a”, “b”, and “c”. Then preset locations information of the multiple preset locations are recorded in the memory 50, such as a preset location information “1” corresponds to the preset location “a”, a preset location information “2” corresponds to the preset location “b”, and a preset location information “3” corresponds to the preset position “c”. The preset positions are preselected positions of the orientation sensor 60 within the classroom 200. The preset location information is represented by three-dimensional coordinates in the classroom 200. Finally, multiple image files are stored in the memory 50, such as image file “1”, image file “2”, and image file “3”. Each image file is marked with a corresponding preset location information, such as the preset location information “1” is marked on the image file “1”, the preset location information “2” is marked on the image file “2”, and the preset location information “3” is marked on the image file

When above presetting procedures are completed, the user A wears the eyeglass frame 10 and enters the classroom 200, the orientation sensor 60 transmits signals to the location tracker 70, and the location tracker 70 receiving the signals of a particular strength detects the current location of the orientation sensor 60. The current location is the actual location of the orientation sensor 60 in the classroom 200. When the current location of the orientation sensor 60 is located at the preset location “a”, the location tracker 70 detects that the orientation sensor 60 is located at the preset location “a”, and the processor 40 reads the image file “1” from the memory 50 and the image file “1” is played through the left and the right lenses 20, 30, that is, the image file “1” of the preset location information “1” is selected for playback, when the current location information is determined to be the same as the preset location information “1”.

Similarly, when the current location of the orientation sensor 60 is at the preset location “b”, the current location information is determined to be the same as the preset location information “2.” The processor 40 thus reads the image file “2” from the memory 50 and the image file “2” is played through the left and the right lenses 20, 30. When the current location of the orientation sensor 60 is determined to be at the preset location “c,” the processor 40 reads the image file “3” from the memory 50 and the image file “3” is played through the left and the right lenses 20, 30.

In the present embodiment, the image file is a picture file which includes at least one picture. For example, the image files 1 and 2 include a picture P1, a picture P2, and a picture Pn. When the orientation sensor 60 is determined to be at a preset location, the left lens 20 and the right lens 30 first regularly play the corresponding first picture of the image file. For example, when the orientation sensor 60 enters the preset location “a”, the left lens 20 and the right lens 30 display the first picture P1 of the image file “1” for a period of five seconds. If within the first five seconds, the orientation sensor 60 moves, and enters the preset location “b”, the left lens 20 and the right lens 30 are given five seconds to play the first picture P1 of the image file “2”. If the orientation sensor 60 remains at the preset location “a” for more than five seconds, the left lens 20 and the right lens 30, play the second picture P2 of the image file “1” for five seconds, that is, if the orientation sensor 60 has been located in one place, then each picture is played in a sequence, until all the pictures of the image file 1 have been played.

The external surface of the eyeglass frame 10 has a jitter sensor 80, where the jitter sensor 80 can be a gyroscope. The jitter sensor 80 is electrically connected with the processor 40. The jitter sensor 80 senses whether the eyeglass frame 10 is shaking or otherwise not steady. For example, when the orientation sensor 60 enters the preset location “a”, the left lens 20 and the right lens 30 play the first picture P1 of the image file “1” for a period of five seconds. If within the first five seconds at the preset location “a”, the user A turns his head, then the eyeglass frame 10 consequently experiences motion, meantime, the movement is sensed by the jitter sensor 80 and a signal is transmitted to the processor 40, the processor 40 via the left lens 20 and the right lens 30 immediately play the second picture P2 of the image file “1” for a period of five seconds. If no motion is detected within the first five seconds, then the first picture P1 of the image file “1” is played for the full five-second period. If motion is detected within any five-second playback period, the next picture in the sequence is played, otherwise each image in the sequence is played for the full period of five seconds, until all the pictures P1 to Pn of the image file 1 are played. This enables the user (the viewer), simply by turning his head, to quickly move through some images he has seen before, or which are of no interest to him.

When the orientation sensor 60 is located at the preset locations “b” and “c”, playing procedure of the left lens 20 and the right lens 30 is similar to that of the preset location “a.”

Although the present disclosure has been specifically described on the basis of these exemplary embodiments, the disclosure is not to be construed as being limited thereto. Various changes or modifications may be made to the embodiments without departing from the scope and spirit of the disclosure.

What is claimed is:

1. A pair of eyeglasses, comprising:
an eyeglass frame defines two receiving holes;
a left lens and a right lens set received in the receiving holes;
a processor;
a memory;
an orientation sensor; and
a location tracker set individually from the eyeglass frame;
wherein the left and right lenses are display devices; the memory is configured to store image files and other data, each image file is marked with a corresponding preset location information; the location tracker tracks a current location of the orientation sensor and transmits a current location information of the orientation sensor to the orientation sensor; the orientation sensor transmits the current location information to the processor; wherein when the processor determines that the current location information is determined to be same as the preset location information, the left and the right lenses play the image file.

2. The pair of eyeglasses as claimed in claim 1, wherein the display device is a liquid crystal display (LCD).

3. The pair of eyeglasses as claimed in claim 1, wherein the processor is set within the eyeglass frame and is electrically connected with the left lens and the right lens.

4. The pair of eyeglasses as claimed in claim 1, wherein the memory is set within the eyeglass frame and is electrically connected with the processor.

5. The pair of eyeglasses as claimed in claim 1, wherein each image file is a picture file and includes at least one picture.

6. The pair of eyeglasses as claimed in claim 1, wherein each image file is a video file including at least one video segment.

7. The pair of eyeglasses as claimed in claim 1, wherein the orientation sensor is set outside the eyeglass frame.

8. The pair of eyeglasses as claimed in claim 1, wherein the orientation sensor is set within the eyeglass frame.

9. The pair of eyeglasses as claimed in claim 1, wherein the orientation sensor is electrically connected with the processor.

10. The pair of eyeglasses as claimed in claim 5, wherein the left lens and the right lens first regularly play the corresponding first picture of the image file, and each picture is played in a sequence.

11. The pair of eyeglasses as claimed in claim 10, wherein an external surface of the eyeglass frame has a jitter sensor.

12. The pair of eyeglasses as claimed in claim 11, wherein the jitter sensor is electrically connected with the processor.

13. The pair of eyeglasses as claimed in claim 11, wherein the jitter sensor senses whether the eyeglass frame is shaking or otherwise not steady; when a movement is sensed by the jitter sensor and a signal is transmitted to the processor, the processor via the left lens and the right lens immediately play a next picture of the image file.

14. The pair of eyeglasses as claimed in claim 11, wherein no motion is detected by the eyeglass frame jitter, then the first picture of the image file is played for a full time period.

15. The pair of eyeglasses as claimed in claim 11, wherein the jitter sensor is a gyroscope.
